(19) United States
(12) Patent Application Publication
(10) Pub. No.: US 2018/0172727 A1
(43) Pub. Date: Jun. 21, 2018

(54) Method and Apparatus for carrier profiling of semiconductors utilizing simultaneous techniques utilizing a simulator and a Field-Programmable Gate Array

(71) Applicant: Mark J. Hagmann, Salt Lake City, UT (US)

(72) Inventor: Mark J. Hagmann, Salt Lake City, UT (US)

(21) Appl. No.: 15/844,045

(22) Filed: Dec. 15, 2017

Related U.S. Application Data
(60) Provisional application No. 62/436,265, filed on Dec. 19, 2016.

(51) Int. Cl. G01Q 60/16; G01Q 10/04

(52) U.S. Cl. CPC G01Q 60/16; G01Q 10/04

(57) ABSTRACT

Numerous carrier profiling techniques may be combined for simultaneous operation of those techniques on a single material sample. A single apparatus utilizing a Field-Programmable Gate Array (“FPGA”) may be utilized to simultaneously operate those techniques. Various hardware components necessary for the given techniques may be operationally connected to the FPGA while simulations may be performed and stored with the apparatus for real-time analysis of results.

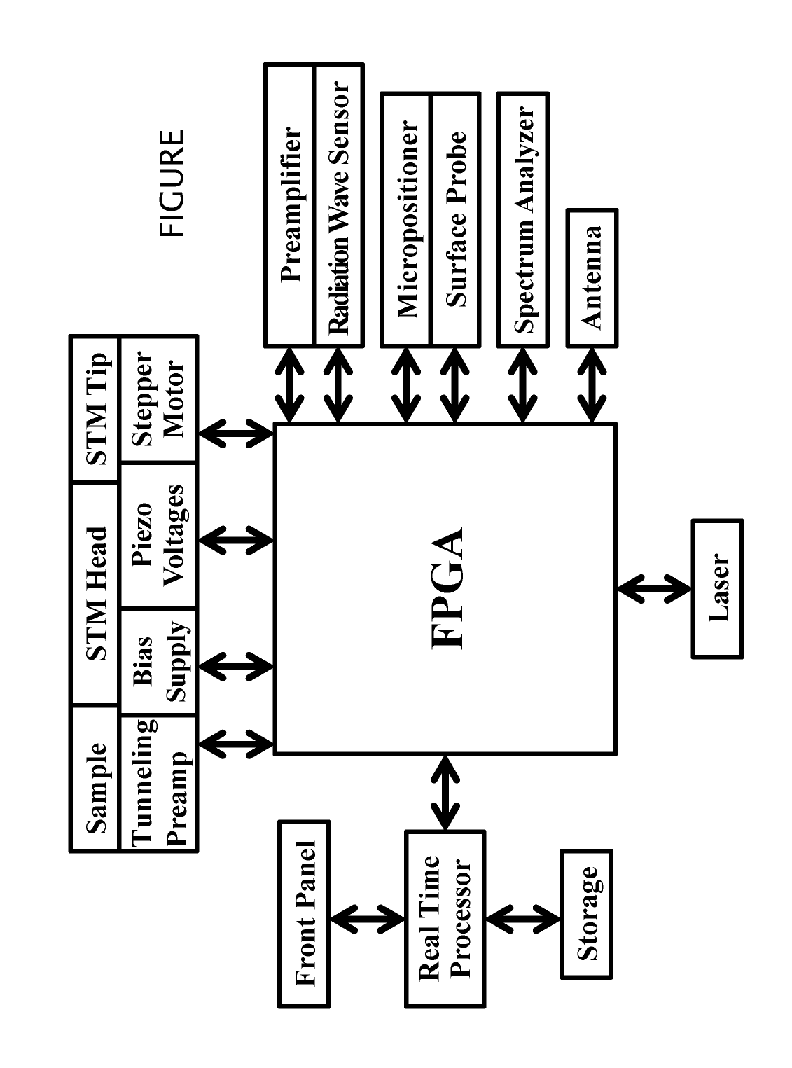

### CROSS-REFERENCES TO RELATED APPLICATIONS

The Application claims priority on prior files U.S. Provisional Application number 62/436,265, filed Dec. 19, 2017, and incorporates the same by reference herein in its entirety.

### FIELD OF THE INVENTION

The present invention relates to the field of carrier profiling of materials and more particularly relates to a method by which a plurality of non-destructive carrier profiling methods is employed on a given sample with the same equipment and optional simulators.

### BACKGROUND OF THE INVENTION

Others have determined the carrier density of semiconductors by iterating measurements of the tunneling current in a scanning tunneling microscope (STM) with the values of the current which are predicted by accurate three-dimensional simulations on a separate computer [K. Fukuda, M. Nishizawa, T. Tada, L. Boltov, K. Suzuki, S. Satoh, H. Arimoto and T. Kanayama, “Three-dimensional simulation of scanning tunneling microscopy for semiconductor carrier and impurity profiling,” Journal of Applied Physics, Vol. 116 (2014) 023701]. However, we introduce a new method in which simulations and two or more new techniques for the measurements are all made in parallel with a single instrument. Thus it is possible to use several of the new techniques at once to obtain greater information about the semiconductor with a fast and efficient manner that is optimized in real-time. The unique combination of a simulator with the new techniques in a single instrument for this method also facilitates maintenance and debugging, as well as in the optimization and characterization of each component and the complete system.

Others have used FPGAs as tools to facilitate specific functions in scanning probe microscopy (SPM). For example, an FPGA has been used to enable real-time cantilever frequency-detection [A. J. Berger, M. R. Page, J. Jacob, J. R. Young, J. Lewis, L. Wenzel, V. P. Bhallamudi, E. Johnston-Halperin, D. V. Pelekhov and P. C. Hammel, “A versatile LabVIEW and field-programmable gate array-based scanning probe microscope for in operando electronic device characterization,” Review of Scientific Instruments, Vol. 85 (2014) 123702], extend the scanning range [F. Kalkan, C. Zaum and K. Morgenstern, “A scanning tunneling microscope with a scanning range from hundreds of micrometers down to nanometer resolution,” Review of Scientific Instruments, Vol. 83 (2012) 103903], or reduce the image acquisition time [F. Esch, C. Dri, A. Spessot, C. Africh, G. Cautero, D. Giuressi, R. Sergo, R. Tommasini and G. Comelli, “The FAST module: An add-on unit for driving commercial scanning probe microscopes at video rate and beyond,” Review of Scientific Instruments, Vol. 82 (2011) 053702]. However, none of the previous art describes the use of two or more techniques that are integrated with a simulator in a single instrument.

The Inventor has previously described three different techniques for carrier profiling of semiconductors by Scanning Frequency Comb Microscopy (SFCM). In each of these techniques a mode-locked ultrafast laser generates a frequency comb of harmonics that extends from microwave through terahertz frequencies within the tunneling junction of a STM. He has further developed a fourth. Different information is obtained by these four techniques because they measure different effects that are caused by the frequency comb in a semiconductor when it is used as the sample electrode in the STM. Importantly, each of the previously described methodologies are non-destructive to the sample, allowing its reuse for further profiling activities. This Application incorporates all the following applications by reference herein in their entireties.

1. In the first technique, described in U.S. Pat. No. 8,601,607 (2013) the STM tunneling junction is reverse-biased to cause a depletion layer in the semiconductor. Modulation of the thickness of the depletion layer by the electric field in the harmonics of the frequency comb changes the resistance and capacitance of the depletion layer to change the frequency-dependent attenuation of the harmonics. The attenuation of the frequency comb is measured to determine the carrier density in a manner that is related to the presently used technique of scanning capacitance microscopy (SCM), described in U.S. Pat. No. 5,065,103 (1991). Both of these patents are incorporated herein by reference in their entirety.

2. In the second technique, described in U.S. Pat. No. 9,442,078 (2016), the tunneling junction of the STM is forward-biased and the attenuation of the frequency comb is measured. This attenuation is primarily caused by the large (˜1 MΩ) spreading resistance at the surface of the semiconductor adjacent to the tunneling junction so the attenuation varies inversely with the carrier density. This technique is related to the presently used technique of scanning spreading resistance microscopy (SSRM) described in U.S. Pat. No. 6,287,880 (2001). Both of these patents are incorporated herein by reference in their entirety.

3. In the third technique, described in U.S. published Application number 20170199221, published Jul. 13, 2017, the tunneling junction in the STM is forward-biased, and each laser pulse creates a sub-nm spot of minority carriers at the surface of the semiconductor. The particles in this spot move rapidly outward into the semiconductor due to their intense mutual electrical repulsion. Simultaneously the majority carriers of the semiconductor are attracted to move inward toward the spot to cause dielectric relaxation. The radial extent of this interaction from the tunneling junction varies inversely with the carrier density in the semiconductor. Thus, measurements of the microwave harmonics of the frequency comb at the surface of the semiconductor are used to determine the local carrier density. This Application is incorporated herein by reference in its entirety.

4. In a variation which could be utilized with each of the three other techniques, one skilled in the art should recognize that an antenna may be used to remotely measure terahertz or microwave radiation generated as a microwave frequency comb. Remote positioning of the antenna can be used in place of a surface probe. This may be more appropriate in terahertz radiation where the dimensions of the tunneling junction are closer to the wavelength of detected radiation. The electrical resistance of the semiconductor at the region adjacent to the tunneling junction acts as a load to attenuate the terahertz radiation so the measured attenuation of this radiation varies inversely with the local value of the carrier density. Others have used near-field confinement of the radiation from a terahertz laser to accomplish carrier profiling with a resolution as fine as 40 nm [Berger, supra], but in technique 4 the resolution may be much finer—comparable to the size of the tunneling junction.

Each of these four techniques has different features. Technique 4 facilitates larger scans over the surface of the semiconductor sample because it does not require that a surface probe be placed on the semiconductor sample and remains within 100 μm of tunneling junction. In general techniques 2, 3, and 4 may provide finer resolution than technique 1. Technique 3 provides the most precisely defined volume for the measurement and may also have the greatest accuracy because this measurement is made in a manner that is analogous to titration in chemistry, but the measurements require more time than is required for the other techniques.

A method by which a plurality of non-destructive carrier profiling characterization techniques may be combined and implemented by a single apparatus is advantageous over the prior art where a single method may be implemented at a time. This represents a departure from the prior art in that the method and apparatus disclosed herein allows for multiple carrier profiling methodologies to be employed near simultaneously, with or without simulations to plan and prepare next measurements with a given sample and debug and interpret results in real time.

### SUMMARY OF THE INVENTION

In view of the foregoing disadvantages inherent in the known types of carrier profiling methodologies and apparatuses, this invention provides a unified method and apparatus for multiple individual characterization methods. As such, the present invention's general purpose is to provide a new and improved apparatus for carrier profiling that is efficient in its ability run multiple characterization methods and to optionally utilize simulations for real-time analysis of measurements acquired from the multiple carrier profile characterization methods. The invention is also the methodology required to run multiple discrete characterization methods simultaneously.

To accomplish these objectives, the apparatus comprises necessary components for various methods of carrier profiling being operably connected to a reconfigurable Field-Programmable Gate Array (FPGA) in which a plurality of characterization methodologies and a plurality of simulations can be stored. Being field-programmable, resources may be allocated at will to accommodate various carrier profiling methodologies now known or later discovered.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are descriptive and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWING

The FIGURE is a block diagram depicting a virtual instrument suitable for implementation of the carrier profiling methodology described herein.

### DETAILED DESCRIPTION OF THE PREFERRED EMBODIMENT

With reference now to the drawings, the preferred embodiment of the apparatus and method is herein described. It should be noted that the articles “a”, “an”, and “the”, as used in this specification, include plural referents unless the content clearly dictates otherwise.

Referring to the FIGURE, a single instrument performs carrier profiling by any or all of the four techniques which were just described as well as enabling scanning tunneling microscopy in the constant current or constant height mode and scanning tunneling spectroscopy. Furthermore, the instrument provides simulations that may be integrated with the measurements to permit optimization in preparations for a measurement as well as continuous real-time interpretation of the data and automatic adjustments of the parameters in real time as the measurements are made.

These features are made possible by using a multi-function instrument for which the block diagram is shown in the FIGURE. Note that no personal computer is required. The functions for measurement, analysis, control, and simulations may be written in LabVIEW, MATLAB, or other suitable programming environments. A command from the Front Panel reconfigures one or more FPGAs to perform different tasks with deterministic operation in real time. The FPGA only processes logic to create outputs in response to its inputs in a specific manner that may be reconfigured. Thus, real-time deterministic control is possible without the delays and interruptions that would be caused by controlling the response directly with a CPU. Furthermore, the FPGA may control many different processes in parallel. Storage is also provided to store measured data and programmed and developed algorithms and methods.

Since the software and the FPGA are relatively inexpensive all four of the new techniques we have listed for carrier profiling could be included in each instrument without causing a major increase in cost over that for only one of these techniques. However, specific hardware is required in some of these techniques (e.g. spectrum analyzer, preamplifier, radiation wave sensor (terahertz or microwave), surface probe, and micropositioner) in addition to the mode-locked laser and the STM head, which may include positioning means (piezoelectric actuators and stepper motors), a bias supply, a DC tunneling preamplifier, and tip and sample electrodes that are necessary for all of the four techniques. Two or more of the four techniques may be used simultaneously. For example, technique 4 does not interfere with any of the other three. Also, the surface probe and micropositioner may be used to make simultaneous measurements for techniques 2 and 3. The simultaneous use of two or more of these four techniques enables a synergy by obtaining information on the carrier density from different perspectives. Other currently known and future techniques and methodologies may be incorporated into the invention by simply providing the appropriate hardware and programming for that additional methodology.

The operation of each function of the instrument may be simulated. FPGAs can implement any digital circuit and any architecture that follows the von Neumann, vector, or GPU model so the simulations are made within the FPGA itself. When simulating the measured STM tunneling current the effects of noise, 1/f fluctuations [Fukuda, supra; S. Sugita, Y. Mera and K. Maeda, “Origin of low frequency noise and 1/f fluctuations of tunneling current in scanning tunneling microscopes,” Journal of Applied Physics, Vol. 79 (1996) 4166-4173]and drift are added to the ideal calculated current. Several different algorithms may be included to simulate the ideal tunneling current to permit different levels of trade-off between accuracy and speed [Fukuda, supra; 6. W. A. Hofer, A. S. Foster and A. L. Shluger, “Theories of scanning probe microscopies at the atomic scale,” Reviews of Modern Physics, Vol. 75 (2003) 1287-1331; R. Zhang, Z. Hu, B. Li and J. Yang, “Efficient method for fast simulation of sanning tunneling microscopy with a tip effect,” Journal of Physical Chemistry, Vol. A-118 (2014) 8953-8959; R. Gaspari, S. Blankenburg, C. A. Pignedoli, P. Ruffieux, M. Trier, R. Fasel and D. Passerone, “s-orbital continuum model accounting for the tip shape in simulated scanning tunneling microscope images,” Physical Review, Vol. B-84 (2011) 125417; N. Garcia, “Theory of scanning tunneling microscopy and spectroscopy: Resolution, image and field states, and thin oxide layers,” IBM Journal of Research and Development, Vol. 30 (1986) 533-542]. In simulating STM imaging in the constant current or constant height mode, scanning tunneling spectroscopy, or the four new techniques for carrier profiling, several three-dimensional models of the sample may be used which have different local values for the topography and material properties.

All of the functions of the STM head may be simulated including the settings and output of the preamplifier, the setting and verification of the bias supply, the voltages to the piezo actuator and their verification. The setting for the stepper motor and its verification may also be simulated. The settings and outputs for the terahertz detector and preamplifier may be simulated. The settings and verifications for the micropositioner and the output from the surface probe may be simulated. The settings and output of the spectrum analyzer, and the settings for the laser may also be simulated.

It is convenient to begin the development of a full instrument using only the simulation functions with no external hardware (e.g. mode-locked laser, STM head, spectrum analyzer, terahertz sensor, surface probe, and micropositioner). After testing and optimization of the software and determining suitable values for the parameters the hardware may be added step by step to facilitate debugging and optimization. The completed full instrument allows each item of the hardware to be switched in or replaced by simulations at any time.

Although the present invention has been described with reference to preferred embodiments, numerous modifications and variations can be made and still the result will come within the scope of the invention. Characterizations of any sample are possible so long as it exhibits some resistivity, as such these methodologies may be practiced on conductors as well as semi-conductors. No limitation with respect to the specific embodiments disclosed herein is intended or should be inferred.

What is claimed is:

1. An apparatus for carrier profiling in a material sample, the apparatus comprising:
a. a field-programmable gate array, the field-programmable gate array being deterministic and having real-time control;
b. a scanning tunneling microscope head; the scanning tunneling microscope head further comprising:
i. a preamplifier
ii. an electrical bias supply;
iii. at least one stepper motor; and
iv. controls for the at least one stepper motor;
c. a front panel for control and monitoring of the field-programmable gate array; and
d. at least one measurement component.

2. The apparatus of claim 1, the at least one measurement component being selected from the set of measurement components consisting of: a spectrum analyzer, a preamplifier and terahertz detector, a surface probe and micropositioner for said surface probe; and an antenna.

3. The apparatus of claim 1, further comprising a laser.

4. The apparatus of claim 3, the at least one measurement component being selected from the set of measurement components consisting of: a spectrum analyzer, a preamplifier and terahertz detector, a surface probe and micropositioner for said surface probe; and an antenna.

5. The apparatus of claim 1 further comprising a storage memory, said storage memory containing simulations of desired characterization methodologies and operations of the instrument.

6. A method for characterizing the carrier profile of a given sample, the method comprising:
a. placing the sample in a scanning tunneling microscope head and activating the head to form a tunneling junction between a scanning tunneling microscope tip the sample;
b. directing a mode-locked ultra-fast laser towards the tunneling junction;
c. running at least two carrier profile characterization methodologies on the sample simultaneously, equipment necessary for running the methodologies being operably connected to the scanning tunneling microscope head through a field-programmable gate array.

7. The method of claim 6, the sample being a semiconductor sample.

8. The method of claim 7, further comprising running simulations on measured profile data for real-time analysis of said measured profile data.

9. The method of claim 8, the equipment necessary for running the methodologies selected from the set of equipment necessary for running the methodologies consisting of: a spectrum analyzer, a preamplifier and terahertz detector, a surface probe and micropositioner for said surface probe; and an antenna.

10. The method of claim 7, the equipment necessary for running the methodologies selected from the set of equipment necessary for running the methodologies consisting of: a spectrum analyzer, a preamplifier and terahertz detector, a surface probe and micropositioner for said surface probe; and an antenna.

11. The method of claim 6, the equipment necessary for running the methodologies selected from the set of equipment necessary for running the methodologies consisting of: a spectrum analyzer, a preamplifier and terahertz detector, a surface probe and micropositioner for said surface probe; and an antenna.
